(19) United States
(12) Patent Application Publication
(10) Pub. No.: US 2018/0109065 A1
(43) Pub. Date: Apr. 19, 2018

(54) AMPLIFIER AND LASER SYSTEM

(71) Applicant: GIGAPHOTON INC., Tochigi (JP)

(72) Inventors: Youichi SASAKI, Tochigi (JP); Shinji ITO, Tochigi (JP); Hironori IGARASHI, Tochigi (JP)

(73) Assignee: GIGAPHOTON INC., Tochigi (JP)

(21) Appl. No.: 15/834,890

(22) Filed: Dec. 7, 2017

Related U.S. Application Data
(63) Continuation of application No. PCT/JP2015/069439, filed on Jul. 6, 2015.

(51) Int. Cl. H01S 3/08; H01S 3/225; H01S 3/23; H01S 3/00; H01S 3/10; H01S 3/097; H01S 3/086

(52) U.S. Cl. CPC H01S 3/08063; H01S 3/225; H01S 3/2308; H01S 3/104; H01S 3/10084; H01S 3/097; H01S 3/086; H01S 3/0057

(57) ABSTRACT

An amplifier may include a chamber, and first and second mirrors. The chamber may include a pair of discharge electrodes opposed to each other in a first direction, a laser exciting medium, an input window allowing seed light to pass therethrough into the chamber, and an output window allowing amplified laser light to pass therethrough to outside in a second direction intersecting with the first direction. The first and second mirrors may each include a reflection region, and be opposed to each other in a third direction intersecting with the first direction with the pair of discharge electrodes in between. A projected image of the reflection region of the first mirror in the second direction and a projected image of the reflection region of the second mirror in the second direction may provide a gap of a size equal to or greater than zero in between.

### CROSS REFERENCE TO RELATED APPLICATIONS

The present application is a continuation application of International Application No. PCT/JP2015/069439 filed on Jul. 6, 2015. The content of the application is incorporated herein by reference in its entirety.

### BACKGROUND

### 1. Technical Field

The present disclosure relates to an amplifier that amplifies laser light, and a laser system including such an amplifier.

### 2. Related Art

With miniaturization and high integration of a semiconductor integrated circuit, an improvement in resolution has been demanded for a semiconductor exposure apparatus. Hereinafter, the semiconductor exposure apparatus is simply referred to as an “exposure apparatus”. Shortening in a wavelength of light to be outputted from an exposure light source has been in progress accordingly. A gas laser unit is used in place of an existing mercury lamp for the exposure light source. Currently, a KrF excimer laser unit and an ArF excimer laser unit may be used as gas laser units for exposure. The KrF excimer laser unit may output ultraviolet light with a wavelength of 248 nm, and the ArF excimer laser unit may output ultraviolet light with a wavelength of about 193.4 nm.

As current exposure technology, liquid immersion exposure is practically used. In the liquid immersion exposure, a clearance between a projection lens on exposure apparatus side and a wafer is filled with a liquid to change a refractive index of the clearance, thereby shortening an apparent wavelength of light from the exposure light source. When the liquid immersion exposure is performed with use of the ArF excimer laser unit as the exposure light source, ultraviolet light with a wavelength of 134 nm in water is applied to the wafer. This technology is referred to as “ArF liquid immersion exposure”. The ArF liquid immersion exposure is also referred to as “ArF liquid immersion lithography”.

Since a spectral line width in free oscillation of each of the KrF excimer laser unit and the ArF excimer laser unit is wide. e.g., in a range from about 350 pm to about 400 pm, color aberration of laser light (ultraviolet light) that is reduced and projected on the wafer by the projection lens on the exposure apparatus side occurs, which results in decrease in resolution. It is therefore necessary to narrow a spectral line width of laser light to be outputted from the gas laser unit to an extent in which the color aberration is negligible. The spectral line width is also referred to as “spectral width”. Accordingly, a line narrow module including a line narrowing device is provided in a laser resonator of the gas laser unit, which achieves narrowing of the spectral width. Non-limiting examples of the line narrowing device may include an etalon and a grating. The laser unit narrowed in spectral width in this way is referred to as “line narrowing laser unit”. For example, reference is made to Japanese Unexamined Patent Application Publication No. 2001-332792, Japanese Unexamined Patent Application Publication No. 2000-156535, Japanese Unexamined Patent Application Publication No. 2011-014913, Japanese Unexamined Patent Application Publication No. 2004-039767, and U.S. Pat. No. 6,765,945.

### SUMMARY

An amplifier according to an aspect of the present disclosure may include a chamber, a first mirror, and a second mirror. The chamber may include a pair of discharge electrodes, a laser exciting medium, an input window, and an output window. The pair of discharge electrodes may be opposed to each other in a first direction. The input window may allow seed light to pass therethrough into the chamber, and the output window may allow amplified laser light to pass therethrough in a second direction to outside. The second direction may intersect with the first direction. The first mirror and the second mirror may each include a reflection region, and be opposed to each other in a third direction with the pair of discharge electrodes in between. The third direction may intersect with the first direction. A projected image of the reflection region of the first mirror in the second direction and a projected image of the reflection region of the second mirror in the second direction may provide a gap of a size equal to or greater than zero in between.

A laser system according to an aspect of the present disclosure may include an oscillator and an amplifier. The oscillator may be configured to output seed light. The amplifier may be provided in an optical path of the seed light. The amplifier may include a chamber, a first mirror, and a second mirror. The chamber may include a pair of discharge electrodes, a laser exciting medium, an input window, and an output window. The pair of discharge electrodes may be opposed to each other in a first direction. The input window may allow the seed light to pass therethrough into the chamber, and the output window may allow amplified laser light to pass therethrough in a second direction to outside. The second direction may intersect with the first direction. The first mirror and the second mirror may each include a reflection region, and be opposed to each other in a third direction with the pair of discharge electrodes in between. The third direction may intersect with the first direction. A projected image of the reflection region of the first mirror in the second direction and a projected image of the reflection region of the second mirror in the second direction may provide a gap of a size equal to or greater than zero in between.

### BRIEF DESCRIPTION OF THE DRAWINGS

Some example embodiments of the present disclosure are described below as mere examples with reference to the accompanying drawings.

FIG. 1 schematically illustrates a cross-sectional configuration example of a laser system including an amplifier according to a comparative example.

FIG. 2 schematically illustrates a configuration example of the amplifier illustrated in FIG. 1, as viewed from above.

FIG. 3 schematically illustrates a light reflection action by a cylindrical convex mirror in the amplifier illustrated in FIG. 1.

FIG. 4 schematically illustrates a light reflection action by a cylindrical concave mirror in the amplifier illustrated in FIG. 1.

FIG. 5 schematically illustrates a diagram, viewed along arrows A1-A1′ of FIG. 1, of the amplifier illustrated in FIG. 1.

FIG. 6 schematically illustrates a configuration of the amplifier in FIG. 1 together with an optical path of self-oscillation light generated in the amplifier.

FIG. 7 schematically illustrates an example of a spectrum distribution of laser light outputted from the amplifier in FIG. 1.

FIG. 8 schematically illustrates an example of a temporal pulse width of seed light entering the amplifier in FIG. 1.

FIG. 9 schematically illustrates a configuration example of an amplifier as an essential part of a laser system according to a first embodiment.

FIG. 10 schematically illustrates a diagram, viewed along arrows B1-B1′ of FIG. 9, of the amplifier illustrated in FIG. 9.

FIG. 11 schematically illustrates a relationship between a gap and a self-oscillation output in the amplifier illustrated in FIG. 9.

FIG. 12 schematically illustrates a configuration example of an amplifier according to a modification example of the first embodiment.

FIG. 13 schematically illustrates a configuration of a laser system including an amplifier according to a second embodiment.

FIG. 14 schematically illustrates an example of an adjuster mechanism for an attitude of a cylindrical convex mirror and a gap in the amplifier illustrated in FIG. 13.

FIG. 15 schematically illustrates an example of an adjuster mechanism for an attitude of a cylindrical concave mirror and a gap in the amplifier illustrated in FIG. 13.

FIG. 16 is a flowchart illustrating an example of a flow of control by a controller in the laser system illustrated in FIG. 12.

FIG. 17 schematically illustrates a configuration example of a laser system including an amplifier according to a third embodiment.

FIG. 18 schematically illustrates an example of an adjuster mechanism for an attitude of a cylindrical convex mirror in the amplifier illustrated in FIG. 17.

FIG. 19 schematically illustrates an example of an adjuster mechanism for attitudes of first and second cylindrical concave mirrors and gaps D1 and D2 in the amplifier illustrated in FIG. 17.

FIG. 20 schematically illustrates a diagram, viewed along arrows C1-C1′ of FIG. 17, of the amplifier illustrated in FIG. 17.

FIG. 21 schematically illustrates a specific configuration example of a solid-state laser apparatus together with a configuration example of a laser apparatus used for an exposure apparatus.

FIG. 22 illustrates an example of a hardware environment of a controller.

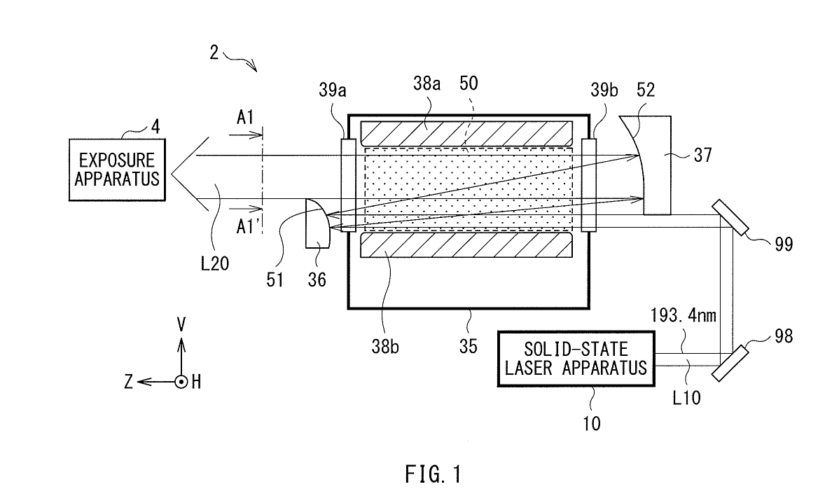

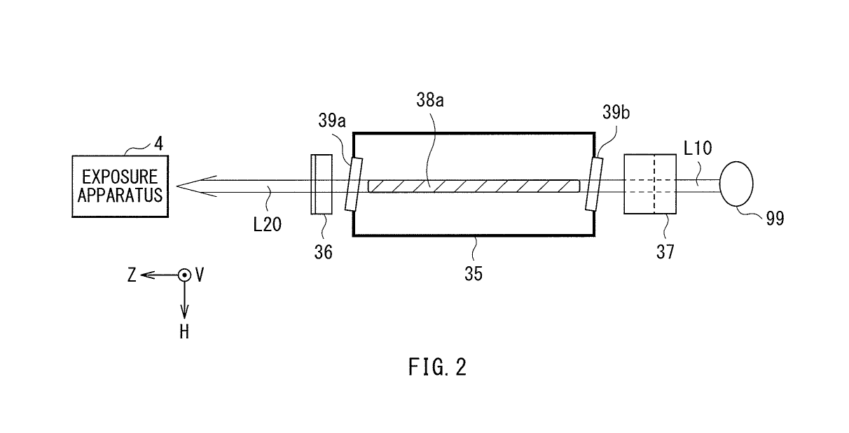

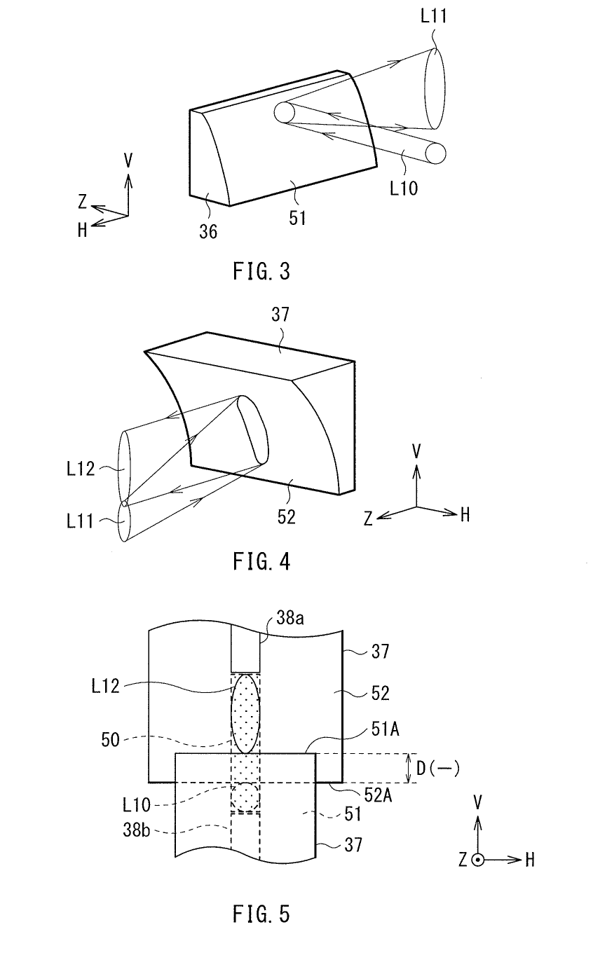

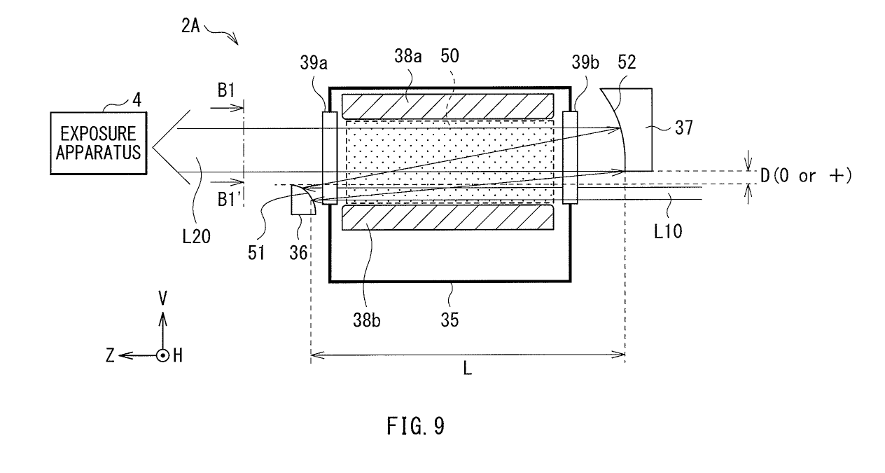

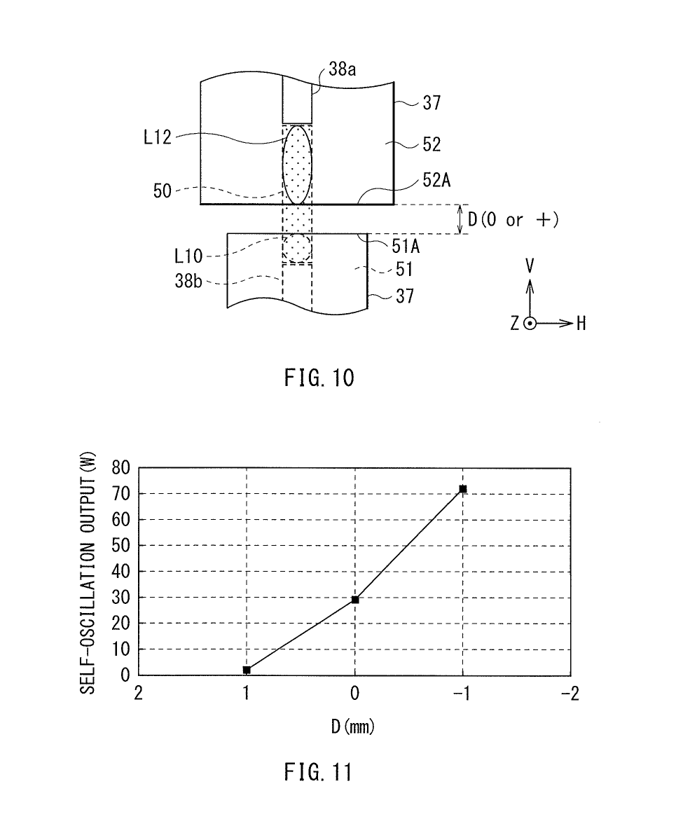

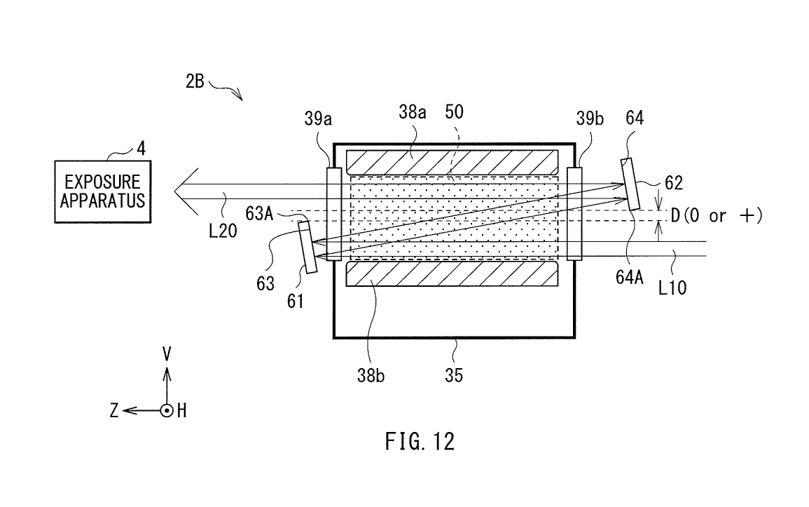

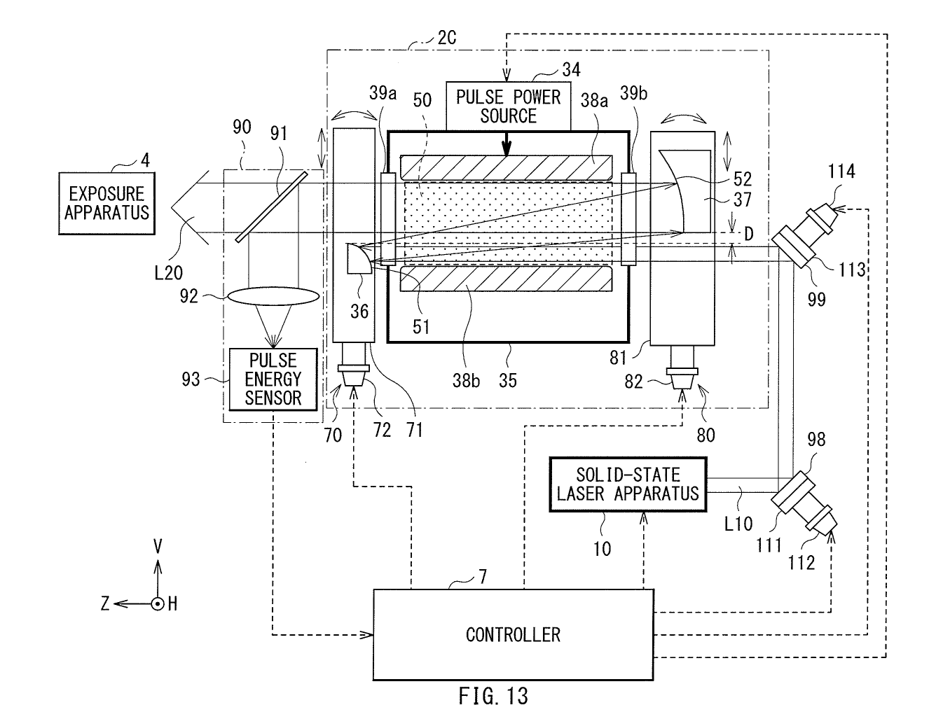

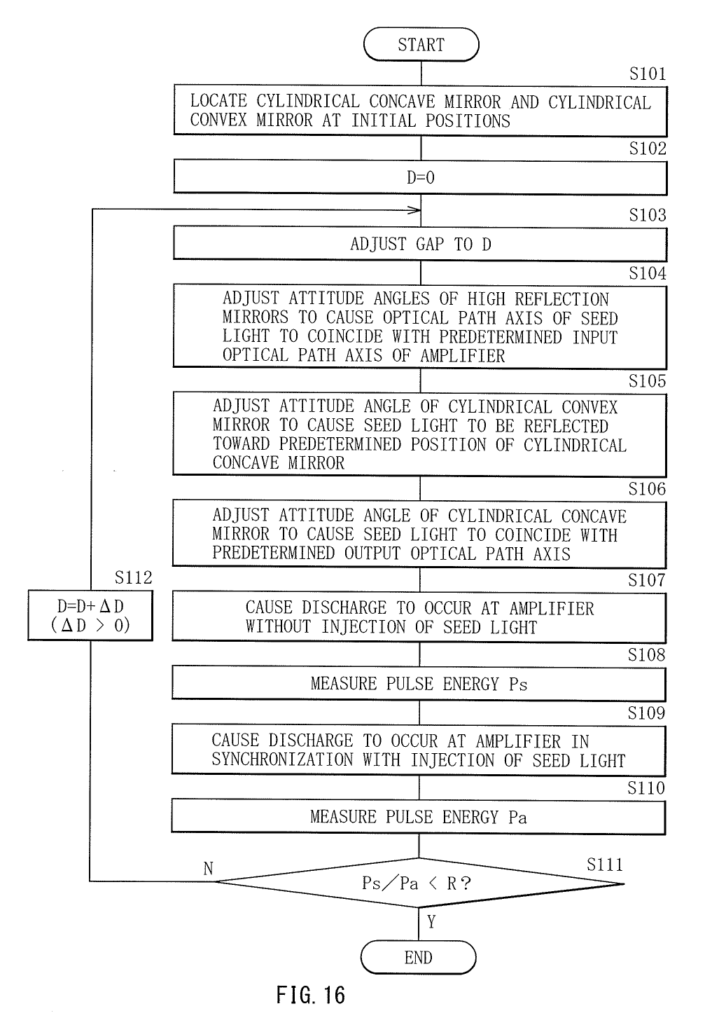

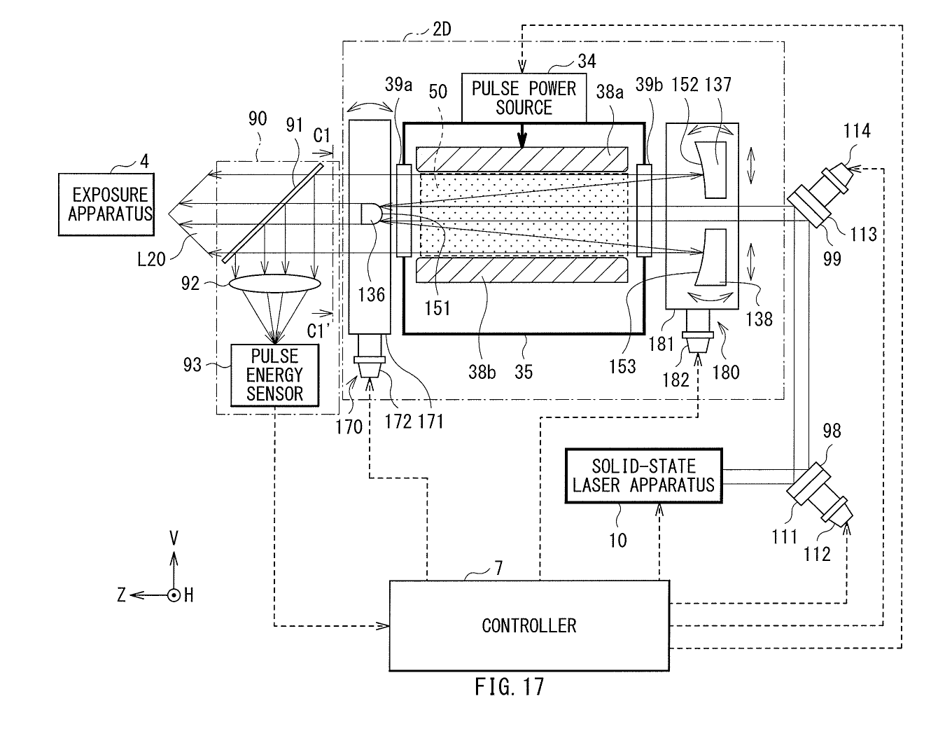

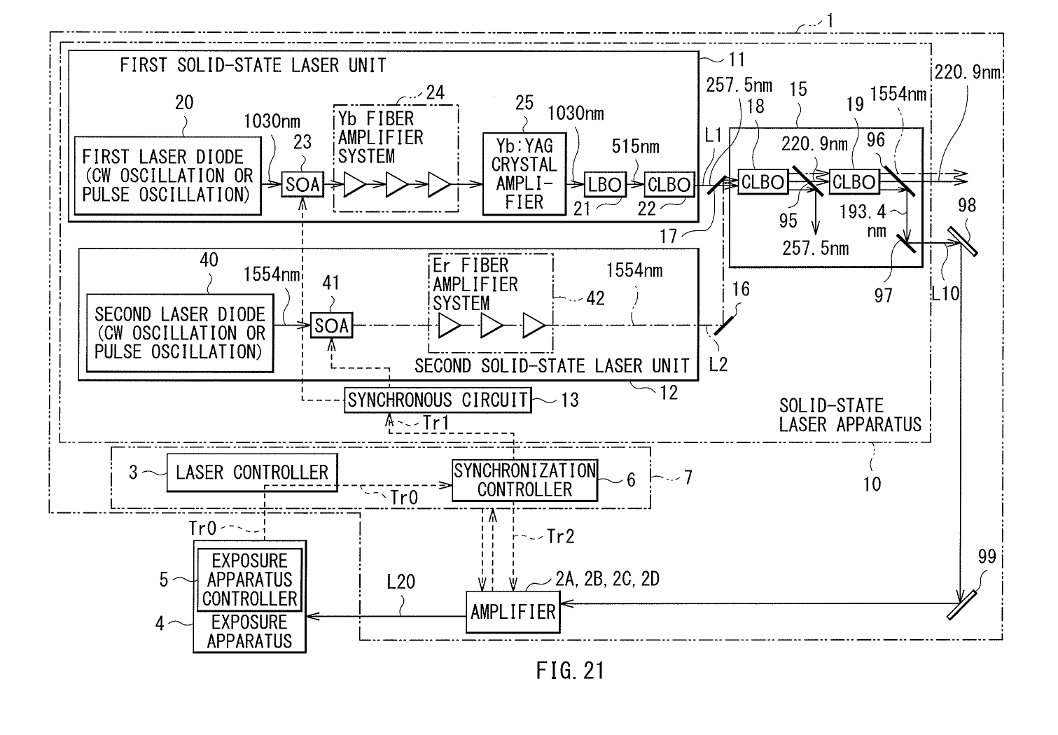

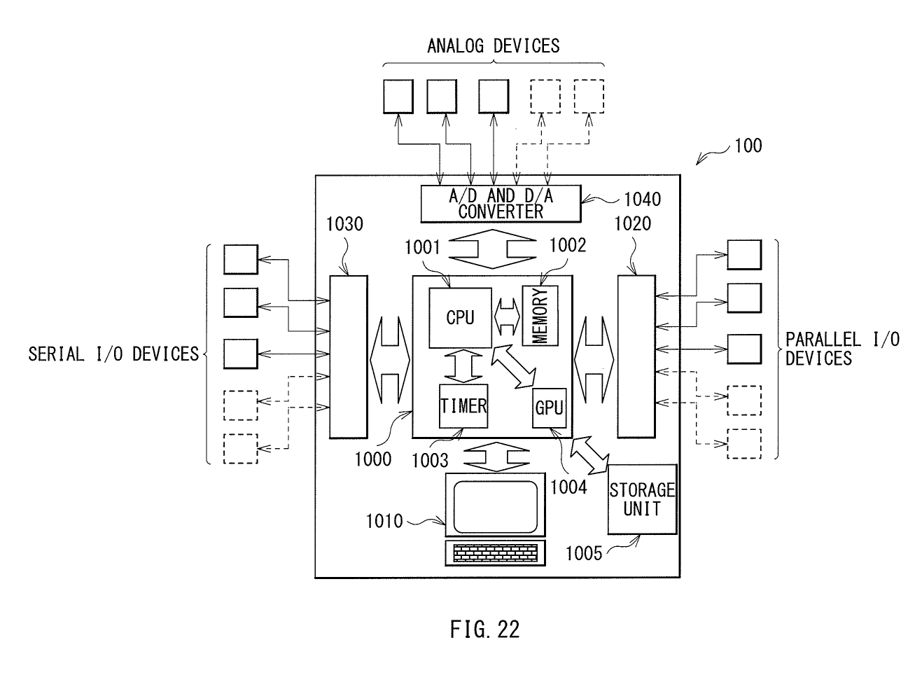

### DETAILED DESCRIPTION

<Contents>
[1. Overview]
[2. Comparative Example] (Laser system including an amplifier that has a configuration of an unstable resonator)
   2.1 Configuration (FIGS. 1 and 2)
   2.2 Operation (FIGS. 3 and 4)
   2.3 Issues (FIGS. 5 to 7)
[3. First Embodiment] (Laser system in which mirrors of an amplifier provide a gap in between)
   3.1 Configuration (FIGS. 9 and 10)
   3.2 Operation (FIG. 11)
   3.3 Workings
   3.4 Modification Example (FIG. 12)
[4. Second Embodiment] (Laser system including an adjuster mechanism for a gap)
   4.1 Configuration (FIGS. 13 to 15)
   4.2 Operation (FIG. 16)
   4.3 Workings
[5. Third Embodiment] (Laser system in which mirrors of an amplifier provide two gaps in between)
   5.1 Configuration (FIGS. 17 to 20)
   5.2 Operation
   5.3 Workings
[6. Specific Example of Solid-state Laser Apparatus]
   6.1 Configuration (FIG. 21)
   6.2 Operation
[7. Hardware Environment of Controller] (FIG. 22)
   [8. Et Cetera]

In the following, some example embodiments of the present disclosure are described in detail with reference to the drawings. Example embodiments described below each illustrate one example of the present disclosure and are not intended to limit the contents of the present disclosure. Further, all of the configurations and operations described in each example embodiment are not necessarily essential for the configurations and operations of the present disclosure. Note that like components are denoted by like reference numerals, and redundant description thereof is omitted.

### 1. Overview

The present disclosure relates to an amplifier that amplifies laser light, and a laser system including such an amplifier,

### 2. Comparative Example

First, description is given of an amplifier according to a comparative example with respect to example embodiments of the present disclosure, and a laser system including the amplifier according to the comparative example.

A laser apparatus used for an exposure apparatus may have a configuration including a master oscillator (MO) and a power oscillator (PO). In such a laser apparatus used for the exposure apparatus, a laser using an excimer laser gas as a laser medium may be used for the MO and the PO. However, in term of energy saving, development of a laser apparatus that is used for an exposure apparatus and includes a solid-state laser unit as an MO is in progress. The solid-state laser unit is configured of a combination of a nonlinear crystal and a solid-state laser, and outputs a pulsed laser light beam of ultraviolet light. In the following, description is given of a configuration example of a laser system applicable as the laser apparatus that is used for the exposure apparatus and includes such a solid-state laser unit.

### 2.1 Configuration

FIG. 1 schematically illustrates a configuration example of a laser system including an amplifier 2 according to the comparative example with respect to example embodiments of the present disclosure. FIG. 2 schematically illustrates a configuration example of the amplifier 2 illustrated in FIG. 1, as viewed from above.

The laser system may include a solid-state laser apparatus 10 serving as an oscillator, high reflection mirrors 98 and 99, and the amplifier 2.

The solid-state laser apparatus 10 may be a laser apparatus that outputs a pulsed laser light beam with a wavelength of about 193.4 nm as seed light L10. The high reflection mirrors 98 and 99 may be optical devices disposed in an optical path of the seed light L10 between the solid-state laser apparatus 10 and the amplifier 2 so as to allow the seed light L10 outputted from the solid-state laser apparatus 10 to enter the amplifier 2.

The amplifier 2 may include a chamber 35, a cylindrical convex mirror 36 serving as a first mirror, and a cylindrical concave mirror 37 serving as a second mirror. The chamber 35 may contain, for example, an ArF laser gas as a laser exciting medium. The ArF laser gas may include an Ar gas as a rare gas, an F₂ gas as a halogen gas, and a Ne gas as a buffer gas. Moreover, a pair of discharge electrodes 38a and 38b may be disposed in the chamber 35 to be opposed to each other in a first direction with a discharge clearance 50 in between. The first direction here may be a direction substantially parallel to a V-axis direction illustrated in FIG. 1. The V-axis direction may be a direction substantially parallel to an upward-downward direction of a paper sheet in FIG. 1.

The chamber 35 may include a window 39a and a window 39b. The window 39b may be an input window allowing the seed light L10 outputted from the solid-state laser apparatus 10 to first pass therethrough into the chamber 35 via the high reflection mirrors 98 and 99. The window 39a may be an output window allowing amplified laser light L20 of the seed light L10 to eventually pass therethrough from the chamber 35 to outside. The amplified laser light L20 may pass through the window 39a to outside in a second direction intersecting with the first direction. The second direction that is an output direction of the amplified laser light L20 here may be a direction that is substantially orthogonal to the V-axis direction illustrated in FIG. 1 and substantially parallel to a Z-axis direction. The Z-axis direction may be a direction substantially parallel to a rightward-leftward direction of the paper sheet in FIG. 1.

The window 39a and the window 39b may be so disposed as to be inclined with respect to a discharge plane by the pair of discharge electrodes 38a and 38b, as illustrated in FIG. 2. The discharge plane here may be a plane including a V axis and a Z axis illustrated in FIG. 1. The plane including the V axis and the Z axis may be a plane substantially parallel to the paper sheet in FIG. 1.

The cylindrical convex mirror 36 and the cylindrical concave mirror 37 may be opposed to each other in a third direction with the pair of discharge electrodes 38a and 38b in between. The third direction may intersect with the V-axis direction that is the first direction. The cylindrical convex mirror 36 may include a convex reflection surface 51 serving as a reflection region. The cylindrical concave minor 37 may include a concave reflection surface 52 serving as a reflection region.

The convex reflection surface 51 of the cylindrical convex mirror 36 may be coated with a high reflection film that reflects light with a wavelength of about 193.4 nm at high reflectivity. Likewise, the concave reflection surface 52 of the cylindrical concave mirror 37 may be coated with a high reflection film that reflects light with a wavelength of about 193.4 nm at high reflectivity. The cylindrical convex mirror 36 and the cylindrical concave mirror 37 may be so disposed as to allow the seed light L10 to pass through the discharge clearance 50 three times. Moreover, the cylindrical convex mirror 36 and the cylindrical concave mirror 37 may be so disposed as to configure an unstable resonator. Further, the cylindrical convex mirror 36 and the cylindrical concave mirror 37 may configure a beam expander. In this case, the beam expander may be so configured as to allow a beam expanding direction to substantially coincide with a discharging direction between the pair of discharge electrodes 38a and 38b. Thus, the amplifier 2 may be configured to perform amplified oscillation on the seed light L10 in the discharge clearance 50 while expanding a beam of the seed light L10 in the discharging direction.

### 2.2 Operation

The seed light L10 with a wavelength of about 193.4 nm outputted from the solid-state laser apparatus 10 may pass through a region lower than a bottom end of the cylindrical concave mirror 37 of the amplifier 2 via the high reflection mirrors 98 and 99 and travel in parallel to an axis in a longitudinal direction of the pair of discharge electrodes 38a and 38b into the discharge clearance 50. The seed light L10 may travel in parallel to the axis in the longitudinal direction of the pair of discharge electrodes 38a and 38b in the discharge clearance 50, thereby being amplified. Thereafter, the thus-amplified seed light L10 may enter the cylindrical convex mirror 36.

FIG. 3 schematically illustrates a light reflection action by the cylindrical convex mirror 36. The seed light L10 reflected by the cylindrical convex mirror 36 at high reflectivity may pass through the discharge clearance 50 as reflected light L11 while expanding a beam of the reflected light L11, thereby being further amplified. Thereafter, the thus-amplified reflected light L11 may enter the cylindrical concave mirror 37.

FIG. 4 schematically illustrates a light reflection action by the cylindrical concave mirror 37. The reflected light L11 having entered the cylindrical concave mirror 37 may be further reflected by the cylindrical concave mirror 37 at high reflectivity. Reflected light L12 by the cylindrical concave mirror 37 may pass through the discharge clearance 50 again while being collimated with respect to the axis in the longitudinal direction of the pair of discharge electrodes 38a and 38b, thereby being further amplified, as illustrated in FIGS. 1 and 4. Most of the collimated reflected light L12 of the seed light L10 may pass through a region above a top end of the cylindrical convex mirror 36 to enter an exposure apparatus 4 as amplified laser light L20. However, a part of the reflected light L12 of the seed light L10 may enter a region below the top end of the cylindrical convex mirror 36 to be reflected, and may be triple-pass amplified again to cause amplified oscillation.

### 2.3 Issues

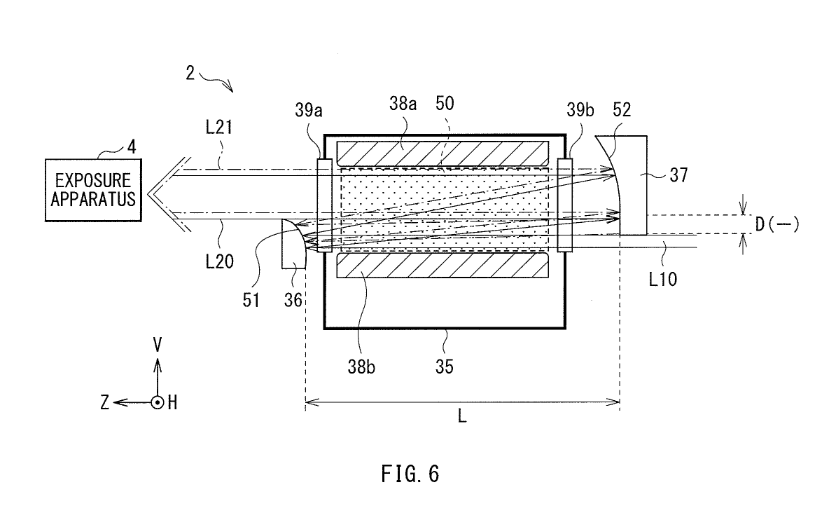

FIG. 5 schematically illustrates a diagram, viewed along arrows A1-A1′ of FIG. 1, of the amplifier 2 illustrated in FIG. 1. Moreover, FIG. 6 schematically illustrates a configuration of the amplifier 2 together with an optical path of self-oscillation light generated in the amplifier 2. It is to be noted that FIG. 5 may illustrate a configuration example of the amplifier 2, as viewed from a direction parallel to the output direction of the amplified laser light L20 that is the second direction.

The cylindrical convex mirror 36 and the cylindrical concave mirror 37 may be so disposed as to cause a state in which a top end 51A of the convex reflection surface 51 and a bottom end 52A of the concave reflection surface 52 provide a gap D(−) of a minus size in between, as viewed from the direction parallel to the output direction of the amplified laser light L20. The state in which the top end 51A of the convex reflection surface 51 and the bottom end 52A of the concave reflection surface 52 provide the gap D(−) of a minus size in between in the configuration example in FIG. 5 may be a state in which the convex reflection surface 51 and the concave reflection surface 52 provide an overlap portion, as viewed from the direction parallel to the output direction of the amplified laser light L20. In the configuration example in FIG. 5, the top end 51A of the convex reflection surface 51 may be located above the bottom end 52A of the concave reflection surface 52 to cause a state in which the convex reflection surface 51 and the concave reflection surface 52 partially overlap each other, as viewed from the direction parallel to the output direction of the amplified laser light L20. Hence, a projected image of the convex reflection surface 51 in the output direction of the amplified laser light L20 and a projected image of the concave reflection surface 52 in the output direction of the amplified laser light L20 may partially overlap each other.

Note that in the specification, the “projected image” may be defined as a normally rotated image formed by transfer of each of an image of the reflection region of the first mirror and an image of the reflection region of the second mirror at 1:1 on a predetermined plane orthogonal to the output direction of the amplified laser light L20. For example, in the example in FIG. 1, the projected image may be defined as a normally rotated image formed by transfer of each of an image of the convex reflection surface 51 and an image of the concave reflection surface 52 at 1:1 on a predetermined plane indicated by the arrows A1-A1′.

In a case where the cylindrical convex mirror 36 and the cylindrical concave mirror 37 are disposed at a mirror distance L from each other in the direction parallel to the output direction of the amplified laser light L20 and are disposed to provide the foregoing gap D(−) of a minus size in between, the following issues may arise.

The convex reflection surface 51 and the concave reflection surface 52 partially overlap each other in the direction parallel to the output direction of the amplified laser light L20, and an overlap portion between the convex reflection surface 51 and the concave reflection surface 52 may configure an optical resonator. As a result, the amplifier 2 may output the amplified laser light L20 that is the amplified seed light L10 and laser light including self-oscillation light L21 amplified by self-oscillation, as illustrated in FIG. 6. It is to be noted that the self-oscillation light L21 may be generated even in a period in which the seed light L10 does not enter the amplifier 2.

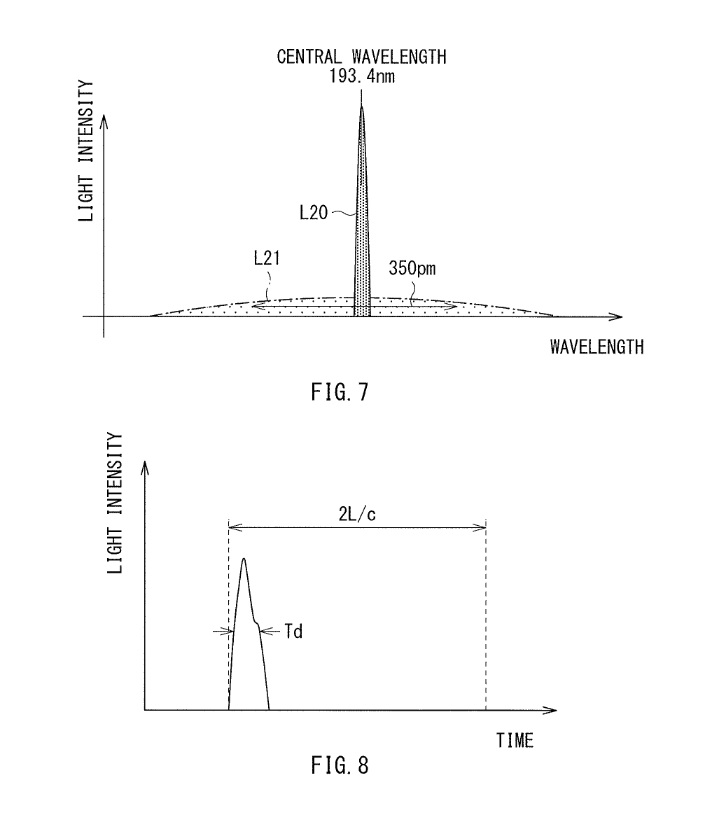

FIG. 7 schematically illustrates an example of a spectrum distribution of laser light outputted from the amplifier 2. It is to be noted that a horizontal axis and a vertical axis in FIG. 7 may indicate wavelength and light intensity, respectively. A spectrum waveform of the laser t outputted from the amplifier 2 may include the amplified laser light L20 that is the amplified seed light L10 and the self-oscillation light L21 amplified by self-oscillation, as illustrated in FIG. 7. Moreover, a spectrum waveform of the self-oscillation light L21 may be extremely wider in spectral width than a spectrum waveform of the amplified laser light L20 of the seed light L10. The spectrum waveform of the self-oscillation light L21 may have, for example, a full width at half maximum of 350 pm. Further, a spectral region of the self-oscillation light L21 amplified by self-oscillation may include a spectral region of the amplified laser light L20 of the seed light L10. This may cause color aberration in a projection optical system in the exposure apparatus 4, which may result in decrease in exposure performance and light concentrating performance.

FIG. 8 schematically illustrates an example of a temporal pulse width Td of the seed light L10 entering the amplifier 2. It is to be noted that a horizontal axis and a vertical axis in FIG. 8 may indicate time and light intensity, respectively. Moreover, “2L/c” illustrated in FIG. 8 may indicate time necessary for the seed light L10 to reciprocate between the cylindrical convex mirror 36 and the cylindrical concave mirror 37. A pulse length Td·c corresponding to the temporal pulse width Td of the seed light L10 may be shorter than an optical path length 2L of the unstable resonator configured of the cylindrical convex mirror 36 and the cylindrical concave mirror 37, as illustrated in FIG. 8 and the following expression. In this case, it may be difficult to perform discharge in a state in which the discharge clearance 50 of the amplifier 2 is fully filled with the seed light L10. This may make it difficult to suppress self-oscillation.

c·Td<2L

where Td is a pulse width (full width at half maximum) of the seed light L10, c is light speed, L is a mirror distance in the direction parallel to the output direction of the amplified laser light L20 from the cylindrical convex mirror 36 to the cylindrical concave mirror 37.

### 3. First Embodiment

Next, description is given of a laser system including an amplifier according to a first embodiment of the present disclosure. Note that substantially same components as the components of the foregoing laser system including the amplifier 2 illustrated in FIG. 1 are denoted by same reference numerals, and redundant description thereof is omitted.

### 3.1 Configuration

FIG. 9 schematically illustrates a configuration example of an amplifier 2A as an essential part of the laser system according to the first embodiment of the present disclosure. FIG. 10 schematically illustrates a diagram, viewed along arrows B1-B1′ of FIG. 9, of the amplifier 2A illustrated in FIG. 9. It is to be noted that FIG. 10 may illustrate a configuration example of the amplifier 2A, as viewed from the direction parallel to the output direction of the amplified laser light L20 that is the second direction.

The laser system according to the present embodiment may include the amplifier 2A illustrated in FIG. 9 in place of the amplifier 2 according to the comparative example illustrated in FIG. 1. As with the foregoing amplifier 2 according to the comparative example, the amplifier 2A may be so configured as to allow the seed light L10 from the solid-state laser apparatus 10 to enter the amplifier 2A. The seed light L10 outputted from the solid-state laser apparatus 10 may be a pulsed laser light beam satisfying the condition of c·Td<2L, as described above.

The amplifier 2A may have a configuration different in positions of the cylindrical convex mirror 36 and the cylindrical concave mirror 37 from the configuration of the amplifier 2 according to the comparative example. In the amplifier 2A, the cylindrical convex mirror 36 and the cylindrical concave mirror 37 may be so disposed as to suppress self-oscillation.

More specifically, the cylindrical convex mirror 36 and the cylindrical concave mirror 37 may be so disposed as to cause a state in which the top end 51A of the convex reflection surface 51 and the bottom end 52A of the concave reflection surface 52 provide a gap D of a size equal to or greater than zero in between, as viewed from the direction parallel to the output direction of the amplified laser light L20. The gap D of a size equal to or greater than zero may be the gap D of a size equal to zero or the gap D of a plus size. A state in which the top end 51A of the convex reflection surface 51 and the bottom end 52A of the concave reflection surface 52 provide the gap D of a size equal to zero in between here may be a state in which the top end 51A of the convex reflection surface 51 and the bottom end 52A of the concave reflection surface 52 are in contact with each other, as viewed from the direction parallel to the output direction of the amplified laser light L20. Moreover, a state in which the top end 51A of the convex reflection surface 51 and the bottom end 52A of the concave reflection surface 52 provide the gap D of a plus size in between may be a state in which the convex reflection surface 51 and the concave reflection surface 52 do not overlap each other and are separated from each other, as viewed from the direction parallel to the output direction of the amplified laser light L20. As illustrated in FIG. 10, the top end 51A of the convex reflection surface 51 is located below the bottom end 52A of the concave reflection surface 52 to cause the state in which the convex reflection surface 51 and the concave reflection surface 52 do not overlap each other and are separated from each other, as viewed from the direction parallel to the output direction of the amplified laser light L20.

As described above, the amplifier 2A may have a configuration in which the projected image of the convex reflection surface 51 in the output direction of the amplified laser light L20 and the projected image of the concave reflection surface 52 in the output direction of the amplified laser light L20 provide the gap D of a size equal to or greater than zero in between.

Other configurations may be substantially similar to those in the laser system including the amplifier 2 according to the comparative example illustrated in FIG. 1.

### 3.2 Operation

In the amplifier 2A, the cylindrical convex mirror 36 and the cylindrical concave mirror 37 are so disposed as to suppress self-oscillation, which may suppress generation of the self-oscillation light L21, as compared with the foregoing comparative example. Accordingly, the amplifier 2A may serve as an amplifier mainly for the seed light L10.

FIG. 11 is a graph schematically illustrating a relationship between the gap D and a self-oscillation output in the amplifier 2A illustrated in FIG. 9, A horizontal axis and a vertical axis in FIG. 11 may indicate the size (mm) of the gap D and a value (W) of the self-oscillation output, respectively. Moreover, the graph in FIG. 11 may be obtained under the following conditions.
Mirror distance L from the cylindrical convex mirror 36 to the cylindrical concave mirror 37=1000 mm
The temporal pulse width Td of the seed light L10=4 ns (full width at half maximum)
Pulse energy of the seed light L10=16 μJ
Beam magnification from 3 times to 8 times
Electrode distance between the pair of discharge electrodes 38a and 38b=16 mm
Repetition frequency of the seed light L10 and repetition frequency of discharge of the amplifier 2A=6 kHz

For example, in a case where an output from the amplifier 2A is 200 W, the size of the gap D may be preferably equal to or greater than zero, which may cause the self-oscillation output to be 30 W or less, as illustrated in FIG. 11. The size of the gap D may be more preferably equal to or greater than +1.0 mm, which may cause the self-oscillation output to be 1 W or less.

A probable cause of generation of self-oscillation in spite of the size of the gap D being equal to zero may be scattering of light at an edge facing the discharge clearance 50 of the cylindrical convex mirror 36 and an edge facing the discharge clearance 50 of the cylindrical concave mirror 37. The edge facing the discharge clearance 50 of the cylindrical convex mirror 36 may correspond to the top end 51A of the convex reflection surface 51, and the edge facing the discharge clearance 50 of the cylindrical concave mirror 37 may correspond to the bottom end 52A of the concave reflection surface 52. Hence, the size of the gap D being equal to or greater than +1 mm may further suppress self-oscillation.

Moreover, the gap D may preferably satisfy the following conditions for the mirror distance L from the cylindrical convex mirror 36 to the cylindrical concave mirror 37 and the electrode distance between the pair of discharge electrodes 38a and 38b. More specifically, the gap D may be smaller than the electrode distance between the pair of discharge electrodes 38a and 38b. Moreover, the gap D may be equal to or greater than L/1000 (mm).

Electrode distance>>D≥L/1000 (mm)

### 3.3 Workings

According to the laser system of the present embodiment, the cylindrical convex mirror 36 and the cylindrical concave mirror 37 are so disposed as to provide the gap D of a size equal to or greater than zero in between, which makes it possible to suppress self-oscillation in the amplifier 2A. This makes it possible for the amplifier 2A to amplify laser light with high spectrum purity, which makes it possible to suppress decrease in exposure performance and light concentrating performance of the exposure apparatus 4.

### 3.4 Modification Example

FIG. 12 schematically illustrates a configuration example of an amplifier 2B according to a modification example of the first embodiment.

The amplifier 2B according to the present modification example may include a first plane mirror 61 serving as the first mirror and a second plane mirror 62 serving as the second mirror in place of the cylindrical convex mirror 36 and the cylindrical concave mirror 37 in the foregoing amplifier 2A.

The first plane minor 61 and the second plane mirror 62 may be disposed to be opposed to each other in the third direction with the pair of discharge electrodes 38a and 38b in between. The third direction may intersect with the V-axis direction that is the first direction. The first plane minor 61 may include a first plane reflection surface as a reflection region. The second plane mirror 62 may include a second plane reflection surface 64 as a reflection region.

Each of the first plane reflection surface 63 and the second plane reflection surface 64 may be coated with a high reflection film that reflects light with a wavelength of about 193.4 nm at high reflectivity. The first plane mirror 61 and the second plane mirror 62 may be so disposed as to allow the seed light L10 to pass through the discharge clearance 50 three times. Moreover, the first plane mirror 61 and the second plane mirror 62 may be so disposed as not to configure an optical resonator

In the amplifier 2B, the first plane mirror 61 and the second plane mirror 62 may be so disposed as to suppress self-oscillation. More specifically, the first plane mirror 61 and the second plane mirror 62 may be so disposed as to cause a state in which a top end 63A of the first plane reflection surface 63 and a bottom end 64A of the second plane reflection surface 64 provide the gap D of a size equal to or greater than zero in between, as viewed from the direction parallel to the output direction of the amplified laser light L20. The gap D of a size equal to or greater than zero may be the gap D of a size equal to zero or the gap D of a plus size. The state in which the top end 63A of the first plane reflection surface 63 and the bottom end 64A of the second plane reflection surface 64 provide the gap D of a size equal to zero in between here may be a state in which the top end 63A of the first plane reflection surface 63 and the bottom end 64A of the second plane reflection surface 64 are in contact with each other, as viewed from the direction parallel to the output direction of the amplified laser light L20. Moreover, a state in which the top end 63A of the first plane reflection surface 63 and the bottom end 64A of the second plane reflection surface 64 provide the gap D of a plus size in between may be a state in which the first plane reflection surface 63 and the second plane reflection surface 64 do not overlap each other and are separated from each other, as viewed from the direction parallel to the output direction of the amplified laser light L20. The top end 63A of the first plane reflection surface 63 is located below the bottom end 64A of the second plane reflection surface 64 to cause the state in which the first plane reflection surface 63 and the second plane reflection surface 64 do not overlap each other and are separated from each other, as viewed from the direction parallel to the output direction of the amplified laser light L20.

As described above, the amplifier 2B may have a configuration in which a projected image of the first plane reflection surface 63 in the output direction of the amplified laser light L20 and a projected image of the second plane reflection surface 64 in the output direction of the amplified laser light L20 provide the gap D of a size equal to or greater than zero in between.

Other configurations and workings may be substantially similar to those in the amplifier 2A illustrated in FIG. 9.

### 4. Second Embodiment

Next, description is given of a laser system including an amplifier according to a second embodiment of the present disclosure. Note that substantially same components as the components of the laser systems according to the foregoing comparative example and the foregoing first embodiment are denoted by same reference numerals, and redundant description thereof is omitted.

### 4.1 Configuration

FIG. 13 schematically illustrates a configuration example of a laser system including an amplifier 2C according to the second embodiment of the present disclosure.

The laser system according to the present embodiment may include the amplifier 2C in place of the amplifier 2A according to the first embodiment illustrated in FIG. 9. Moreover, the laser system according to the present embodiment may include a controller 7, the solid-state laser apparatus 10, the high reflection mirrors 98 and 99, and a pulse energy monitor 90. The solid-state laser apparatus 10 may be electrically coupled to the controller 7, and the controller 7 may control an oscillation timing of the seed light L10.

The high reflection mirror 98 may be contained in a mirror holder 111. The mirror holder 111 may be coupled to an actuator 112 that controls an attitude angle of the high reflection mirror 98 in two axis directions orthogonal to each other. The high reflection mirror 99 may be contained in a mirror holder 113. The mirror holder 113 may be coupled to an actuator 114 that controls an attitude angle of the high reflection mirror 99 in two axis directions orthogonal to each other. The actuators 112 and 114 may be electrically coupled to the controller 7, and the controller 7 may control the attitude angles of the high reflection mirrors 98 and 99.

The amplifier 2C may further include adjuster mechanisms 70 and 80, and a pulse power source 34 in addition to components similar to those of the amplifier 2A according to the foregoing first embodiment. The pulse power source 34 and the adjuster mechanisms 70 and 80 may be electrically coupled to the controller 7. The pulse power source 34 may be a power source that performs power supply for discharge of the pair of discharge electrodes 38a and 38b. The controller 7 may control a timing of power supply by the pulse power source 34 and a timing of discharge of the pair of discharge electrodes 38a and 38b.

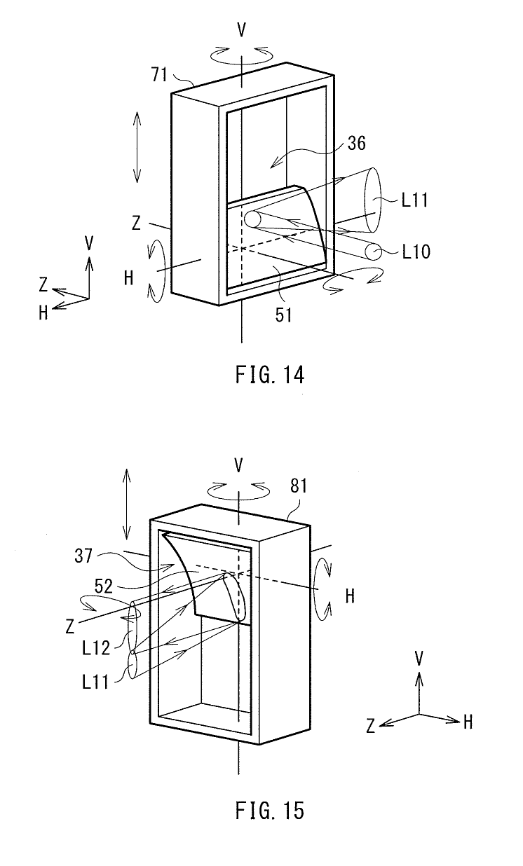

FIG. 14 schematically illustrates an example of the adjuster mechanism 70. The adjuster mechanism 70 may be a mechanism that adjusts an attitude of the cylindrical convex mirror 36 and the gap D. The adjuster mechanism 70 may include an actuator 72 and a convex mirror driver 71 coupled to the actuator 72. The cylindrical convex mirror 36 may be contained in the convex mirror driver 71. The adjuster mechanism 70 may allow the attitude of the cylindrical convex mirror 36 to rotate around each of a V axis, an H axis, and a Z axis as rotation axes, as illustrated in FIG. 14. Moreover, the adjuster mechanism 70 may move a position of the cylindrical convex mirror 36 in the V-axis direction to adjust the gap D.

FIG. 15 schematically illustrates an example of the adjuster mechanism 80. The adjuster mechanism 80 may be a mechanism that adjusts an attitude of the cylindrical concave mirror 37 and the gap D. The adjuster mechanism 80 may include an actuator 82 and a concave mirror driver 81 coupled to the actuator 82. The cylindrical concave mirror 37 may be contained in the concave mirror driver 81. The adjuster mechanism 80 may allow the attitude of the cylindrical concave mirror 37 to rotate around each of the V axis, the H axis, and the Z axis as rotation axes, as illustrated in FIG. 15. Moreover, the adjuster mechanism 80 may move a position of the cylindrical concave mirror 37 in the V-axis direction to adjust the gap D.

The pulse energy monitor 90 may include a beam splitter 91, a light concentrating optical system 92, and a pulse energy sensor 93. The pulse energy monitor 90 may be a monitor that detects pulse energy of the amplified laser light L20 outputted from the amplifier 2C. The beam splitter 91 may be disposed in an optical path of the amplified laser light L20, and may be so disposed as to allow a. part of the amplified laser light L20 to be outputted to the light concentrating optical system 92. The light concentrating optical system 92 may concentrate a part of the amplified laser light L20 branched by the beam splitter 91 and allow the part of the amplified laser light L20 to enter a sensor surface of the pulse energy sensor 93. The pulse energy sensor 93 may detect pulse energy of the amplified laser light L20.

The pulse energy sensor 93 may be electrically coupled to the controller 7 to output a signal indicating a detection result to the controller 7. The controller 7 may control the size of the gap D with use of the adjuster mechanisms 70 and 80 on the basis of pulse energy detected by the pulse energy sensor 93. Moreover, the controller 7 may control the actuators 112 and 114 on the basis of the pulse energy to control the attitude angles of the high reflection mirrors 98 and 99. Further, the controller 7 may control the adjuster mechanisms 70 and 80 on the basis of the pulse energy to control the attitudes of the cylindrical convex mirror 36 and the cylindrical concave mirror 37.

Other configurations may be substantially similar to those in the laser system illustrated in FIG. 9.

### 4.2 Operation

Next, description is given of a specific example of a control operation by the controller 7 with reference to FIG. 16.

The controller 7 may input a trigger signal indicating laser oscillation to the solid-state laser apparatus 10, and may cause the solid-state laser apparatus 10 to output a pulsed laser light beam with a wavelength of about 193.4 nm as the seed light L10. First, the controller 7 may perform control on the cylindrical convex mirror 36 and the cylindrical concave mirror 37 to locate the cylindrical convex mirror 36 and the cylindrical concave mirror 37 at initial positions with use of the adjuster mechanisms 70 and 80 (step S101). At this occasion, an initial adjustment value of the gap D may be zero (step S102). The controller 7 may adjust the gap D to an adjustment value with use of the adjuster mechanisms 70 and 80 (step S103).

Next, the controller 7 may adjust the attitude angles of the high reflection mirrors 98 and 99 with use of the actuators 112 and 114 so as to cause the seed light L10 outputted from the solid-state laser apparatus 10 to coincide with a predetermined input optical path axis of the amplifier 2C (step S104). Thereafter, the controller 7 may adjust the attitude angle of the cylindrical convex mirror 36 with use of the adjuster mechanism 70 so as to cause the seed light L10 to be reflected toward the predetermined position of the cylindrical concave mirror 37 (step S105). Subsequently, the controller 7 may adjust the attitude angle of the cylindrical concave mirror 37 with use of the adjuster mechanism 80 so as to cause the seed light L10 to coincide with a predetermined output optical path axis (step S106).

The controller 7 may perform control to cause discharge to occur at the amplifier 2C without injection of the seed light L10 in this state (step S107). In other words, while the controller 7 may stop output of the seed light L10 from the solid-state laser apparatus 10, the controller 7 may charge the pulse power source 34 of the amplifier 2C and cause discharge to occur at the amplifier 2C. A self-oscillation component generated by discharge may be outputted from the amplifier 2C, branched by the beam splitter 91, and concentrated by the light concentrating optical system 92. Thus, the self-oscillation component may enter the pulse energy sensor 93. The pulse energy sensor 93 may output, to the controller 7, an electrical signal corresponding to an inputted light amount as a detection signal for calculation of the pulse energy. The controller 7 may convert the detection signal into pulse energy with use of a predetermined conversion equation to measure pulse energy Ps of the self-oscillation (step S108). The controller 7 may store a result of the measurement of the pulse energy Ps of the self-oscillation.

Subsequently, the controller 7 may perform control to cause discharge to occur at the amplifier 2C in synchronization with injection of the seed light L10 (step S109). In other words, the controller 7 may output, to the solid-state laser apparatus 10, a trigger signal indicating laser oscillation so as to cause the solid-state laser apparatus 10 to output the seed light L10, and may transmit a discharge signal to the pulse power source 34 so as to perform discharge in synchronization with input of the seed light L10 into the discharge clearance 50 of the amplifier 2C. As a result, the seed light L10 may be amplified by the cylindrical convex mirror 36 and the cylindrical concave mirror 37 while expanding the beam of the seed light L10 in the discharge clearance 50. The seed light L10 amplified by the amplifier 2C may be outputted from the amplifier 2C as the amplified laser light L20, and a part of the amplified laser light L20 may enter the pulse energy monitor 90. The part of the amplified, laser light L20 may be concentrated. by the light concentrating optical system 92, and may enter the pulse energy sensor 93. The pulse energy sensor 93 may output an electrical signal corresponding to an inputted light amount to the controller 7 as a detection signal for calculation of the pulse energy. The controller 7 may convert the detection signal into pulse energy with use of a predetermined conversion equation to measure pulse energy Pa of the amplified laser light L20 (step S110). The controller 7 may store a result of the measurement of the pulse energy Pa of the amplified laser light L20.

Subsequently, the controller 7 may calculate a value of Ps/Pa on the basis of a value of the pulse energy Ps of the self-oscillation and a value of the pulse energy Pa of the amplified laser light L20. Thereafter, the controller 7 may determine whether a condition of Ps/Pa<R is satisfied, that is, whether the value of Ps/Pa is smaller than a predetermined value R (step S111). The predetermined value R here may be, for example, 0.001.

In a case where the controller 7 determines that the condition of Ps/Pa<R is not satisfied (step S11; N), the controller 7 may change the adjustment value of the gap D to D+ΔD (step S112), where ΔD may be a positive value. Thereafter, the controller 7 may return to a process in the step S103 and may perform adjustment by the adjuster mechanisms 70 and 80 to change the gap D by ΔD. The controller 7 may repeat processes in the steps S103 to S112 until the value of Ps/Pa becomes smaller than the predetermined value R. In a case where the controller 7 determines that the condition of Ps/Pa<R is satisfied (step S111; Y), the controller 7 may end the process.

### 4.3 Workings

According to the laser system of the present embodiment, the actuators 72, 82, 112, and 114 are respectively provided for the high reflection mirrors 98 and 99, the cylindrical convex mirror 36, and the cylindrical concave mirror 37, which makes it possible to perform automatic alignment adjustment.

Moreover, the adjuster mechanisms 70 and 80 that are allowed to perform movement adjustment in the V-axis direction are provided for the cylindrical convex mirror 36 and the cylindrical concave mirror 37, which make it possible to automatically adjust the gap D. Further, monitoring pulse energy of light outputted from the amplifier 2C makes it possible to measure the pulse energy Ps of the self-oscillation and the pulse energy Pa of the amplified laser light L20 of the seed light L10. Thus, the value of Ps/Pa indicating a ratio of the self-oscillation is measured while automatically adjusting the gap D, which makes it possible to determine the value of the gap D that causes the value of Ps/Pa to be smaller than the predetermined value R.

Other workings may be substantially similar to those in the laser system illustrated in FIG. 9.

### 5. Third Embodiment

Next, description is given of a laser system including an amplifier according to a third embodiment of the present disclosure. Note that substantially same components as the components of the laser systems according to the foregoing comparative example and the foregoing first and second embodiments are denoted by same reference numerals, and redundant description thereof is omitted.

### 5.1 Configuration

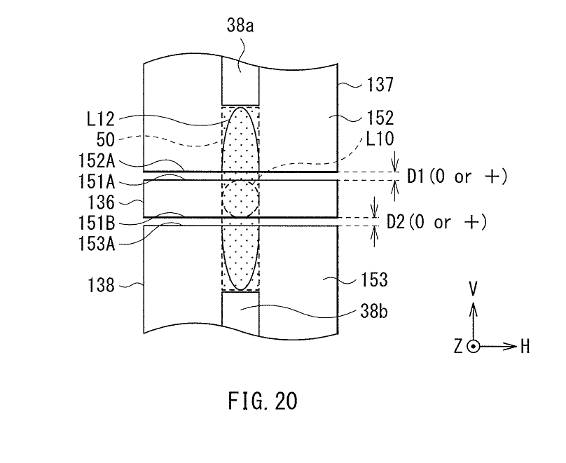

FIG. 17 schematically illustrates a configuration example of a laser system including an amplifier 2D according to a third embodiment of the present disclosure. FIG. 20 schematically illustrates a diagram, viewed along arrows C1-C1′ of FIG. 17, of the amplifier 2D illustrated in FIG. 17. It is to be noted that FIG. 20 may illustrate a configuration example of the amplifier 2D, as viewed from the direction parallel to the output direction of the amplified laser light L20 that is the second direction.

The laser system according to the present embodiment may include the amplifier 2D in place of the amplifier 2C according to the second embodiment illustrated in FIG. 13. The amplifier 2D may include a cylindrical convex mirror 136 serving as the first mirror in place of the cylindrical convex mirror 36 in the foregoing amplifier 2C. Moreover, the amplifier 2D may include a plurality of mirror elements each including a reflection region serving as the second mirror in place of the cylindrical concave mirror 37 in the foregoing amplifier 2C. The plurality of mirror elements may include a first cylindrical concave mirror 137 and a second cylindrical concave mirror 138.

The cylindrical convex mirror 136 and each of the first and second cylindrical concave mirrors 137 and 138 may be disposed to be opposed to each other in the third direction with the pair of discharge electrodes 38a and 38b in between. The third direction may intersect with the V-axis direction that is the first direction. The cylindrical convex mirror 136 may include a convex reflection surface 151 as a reflection region. The first cylindrical concave mirror 137 may include a first concave reflection surface 152 a reflection region. The second cylindrical concave mirror 138 may include a second concave reflection surface 153 as a reflection region.

Each of the convex reflection surface 151 and the first and second concave reflection surfaces 152 and 153 may be coated with a high reflection film that reflects light with a wavelength of about 193.4 nm at high reflectivity. The cylindrical convex mirror 136 may be disposed to locate a focal axis thereof at a substantially central position of the amplified laser light L20. The first and second cylindrical concave mirrors 137 and 138 may be disposed as portions into which one cylindrical concave mirror is divided at a center of a generatrix. The cylindrical convex mirror 136 and the first cylindrical concave mirror 137 may be so disposed as to allow the seed light L10 to pass through a substantially upper half clearance of the discharge clearance 50 three times. Moreover, the cylindrical convex mirror 136 and the second cylindrical concave mirror 138 may be so disposed as to allow the seed light L10 to pass through a substantially lower half clearance of the discharge clearance 50 three times. Further, the cylindrical convex mirror 136 and the first and second cylindrical concave mirrors 137 and 138 may be so disposed as not to configure an optical resonator.

In the amplifier 2D, the cylindrical convex mirror 136 and the first and second cylindrical concave mirrors 137 and 138 may be so disposed as to suppress self-oscillation.

More specifically, as illustrated in FIG. 20, the cylindrical convex mirror 136 and the first cylindrical concave mirror 137 may be so disposed as to cause a state in which a top end 151A of the convex reflection surface 151 and a bottom end 152A of the first concave reflection surface 152 provide a first gap D1 of a size equal to or greater than zero in between, as viewed from the direction parallel to the output direction of the amplified laser light L20. Moreover, the cylindrical convex mirror 136 and the second cylindrical concave mirror 138 may be so disposed as to cause a state in which a bottom end 151B of the convex reflection surface 151 and a top end 153A of the second concave reflection surface 153 provide a second gap D2 of a size equal to or greater than zero in between, as viewed from the direction parallel to the output direction of the amplified laser light L20. Each of the first and second gaps D1 and D2 of a size equal to or greater than zero may be a gap of a size equal to zero or a gap of a plus size.

A state in which the size of the first gap D1 is equal to zero here may be a state in which the top end 151A of the convex reflection surface 151 and the bottom end 152A of the first concave reflection surface 52 are in contact with each other, as viewed from the direction parallel to the output direction of the amplified laser light L20. Moreover, a state in which the size of the second gap D2 is equal to zero may be a state in which the bottom end 151B of the convex reflection surface 151 and the top end 153A of the second concave reflection surface 153 are in contact with each other, as viewed from the direction parallel to the output direction of the amplified laser light L20.

Further, a state in which each of the first and second gaps D1 and D2 is a gap of a plus size may be a state in which the convex reflection surface 151 and each of the first and second concave reflection surfaces 152 and 153 do not overlap each other and are separated from each other, as viewed from the direction parallel to the output direction of the amplified laser light L20. The top end 151A of the convex reflection surface 151 may be located below the bottom end 152A of the first concave reflection surface 152 to cause the state in which the convex reflection surface 151 and the first concave reflection surface 152 do not overlap each other and are separated from each other, as viewed from the direction parallel to the output direction of the amplified laser light L20. Moreover, the bottom end 151B of the convex reflection surface 151 may be located above the top end 153A of the second concave reflection surface 153 to cause the state in which the convex reflection surface 151 and the second concave reflection surface 153 do not overlap each other and are separated from each other, as viewed from the direction parallel to the output direction of the amplified laser light L20.

As described above, the amplifier 2D may have a configuration in which a projected image of the convex reflection surface 151 in the output direction of the amplified laser light L20 and a projected image of the first concave reflection surface 152 in the output direction of the amplified laser light L20 provide the first gap D1 of a size equal to or greater than zero in between and the projected image of the convex reflection surface 151 in the output direction of the amplified laser light L20 and a projected image of the second concave reflection surface 153 in the output direction of the amplified laser light L20 provide the second gap D2 of a size equal to or greater than zero in between.

Moreover, the amplifier 2D may include adjuster mechanisms 170 and 180 in place of the adjuster mechanisms 70 and 80 in the foregoing amplifier 2C. The adjuster mechanisms 170 and 180 may be electrically coupled to the controller 7.

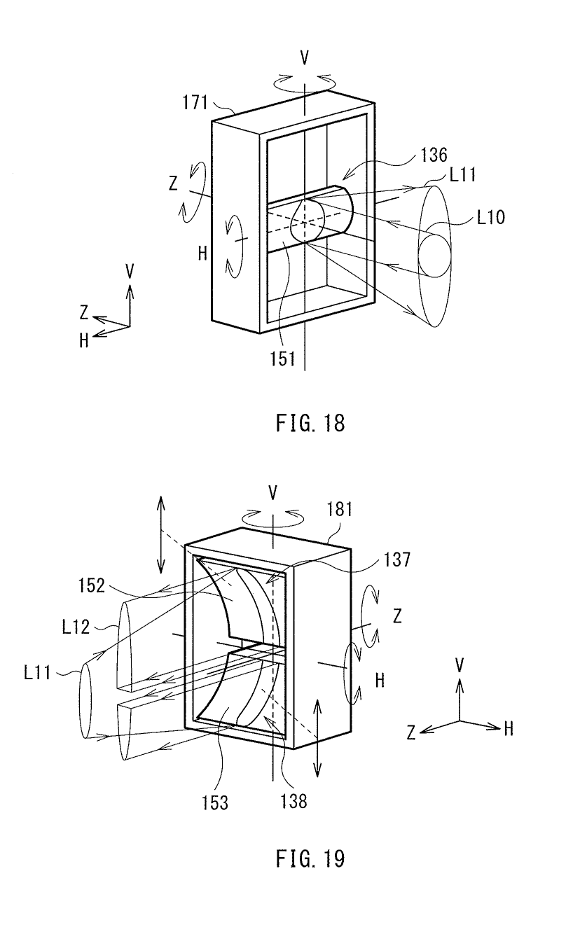

FIG. 18 schematically illustrates an example of the adjuster mechanism 170. The adjuster mechanism 170 may be a mechanism that adjusts an attitude of the cylindrical convex mirror 136. The adjuster mechanism 170 may include an actuator 172 and a convex mirror driver 171 coupled to the actuator 172. The cylindrical convex mirror 136 may be contained in the convex mirror driver 171. The adjuster mechanism 170 may allow the attitude of the cylindrical convex mirror 136 to rotate around each of the V axis, the H axis, and the Z axis as rotation axes, as illustrated in FIG, 18. The adjuster mechanism 170 may move a position of the cylindrical convex mirror 136 in the V-axis direction.

FIG. 19 schematically illustrates an example of the adjuster mechanism 180. The adjuster mechanism 180 may be a mechanism that adjusts attitudes of the first and second cylindrical concave mirrors 137 and 138 and the first and second gaps D1 and D2. The adjuster mechanism 180 may include an actuator 182 and a concave mirror driver 181 coupled to the actuator 182. The first and second cylindrical concave mirrors 137 and 138 may be contained in the concave mirror driver 181. The adjuster mechanism 180 may allow the attitudes of the first and second cylindrical concave mirrors 137 and 138 to rotate around each of the V axis, the H axis, and the Z axis as rotation axes, as illustrated in FIG. 19. Moreover, the adjuster mechanism 180 may independently move positions of the first and second cylindrical concave mirrors 137 and 138 in the V-axis direction to independently adjust the first and second gaps D1 and D2.

The pulse energy sensor 93 may be electrically coupled to the controller 7 to output a signal indicating a detection result to the controller 7. The controller 7 may independently control the sizes of the first and second gaps D1 and D2 with use of the adjuster mechanism 180 on the basis of pulse energy detected by the pulse energy sensor 93. Moreover, the controller 7 may control the actuators 112 and 114 on the basis of the pulse energy to control the attitude angles of the high reflection mirrors 98 and 99. Further, the controller 7 may control the adjuster mechanisms 170 and 180 on the basis of the pulse energy to independently control the attitudes of the cylindrical convex mirror 136 and the first and second cylindrical concave mirrors 137 and 138.

Other configurations may be substantially similar to those in the laser system illustrated in FIG, 13.

### 5.2 Operation

The seed light L10 with a wavelength of about 193.4 nm outputted from the solid-state laser apparatus 10 may pass through a region between the first and second cylindrical concave mirrors 137 and 138 via the high reflection mirrors 98 and 99 and travel in parallel to the axis in the longitudinal direction of the pair of discharge electrodes 38a and 38b into the discharge clearance 50. The seed light L10 may travel in parallel to the axis in the longitudinal direction of the pair of discharge electrodes 38a and 38b in the discharge clearance 50, thereby being amplified. Thereafter, the thus-amplified seed light L10 may enter the cylindrical convex mirror 136.

In the amplifier 2D, the seed light L10 reflected by the cylindrical convex mirror 136 at high reflectivity may pass through a substantially upper half and a substantially lower half of the discharge clearance 50 as the reflected light L11 while expanding the beam of the seed light L10, thereby being further amplified, and thereafter, the thus-amplified reflected light L11 may enter the first and second cylindrical concave mirrors 137 and 138, as illustrated in FIGS. 17 and 18.

The reflected light L11 having entered the first and second cylindrical concave mirrors 137 and 138 may be further reflected by the first and second cylindrical concave mirrors 137 and 138 at high reflectivity. The reflected light L12 by the first and second cylindrical concave mirrors 137 and 138 may pass through the discharge clearance 50 again while being collimated with respect to the axis in the longitudinal direction of the pair of discharge electrodes 38a and 38b, thereby being further amplified, as illustrated in FIGS. 17 and 19. The collimated reflected light L12 of the seed light L10 may pass through a region above the top end 151A of the cylindrical convex mirror 136 and a region below the bottom end 152A of the cylindrical convex mirror 136 to enter the exposure apparatus 4 as the amplified laser light L20.

The adjuster mechanism 180 may independently control movement of the positions of the first and second cylindrical concave mirrors 137 and 138 in the V-axis direction to independently adjust the first and second gaps D1 and D2. It is to be noted that upon adjustment of the first and second gaps D1 and D2, the adjuster mechanism 170 may also control movement of the position of the cylindrical convex mirror 136 in the V-axis direction.

Similar control to the control in the foregoing second embodiment may be performed on the first and second gaps D1 and D2 under a condition of D=D1=D2. In other words, the controller 7 may measure the pulse energy Ps of self-oscillation and the pulse energy Pa of the amplified laser light L20 of the seed light L10 through monitoring the pulse energy of light outputted from the amplifier 2D by the pulse energy monitor 90. Thus, the controller 7 may measure the value of Ps/Pa indicating a ratio of the self-oscillation while automatically adjusting the first and second gaps D1 and D2 to determine values of the first and second gaps D1 and D2 that cause the value of Ps/Pa to be smaller than the predetermined value R. The controller 7 may gradually change the first and second gaps D1 and D2 by the value ΔD toward a positive direction until the value of Ps/Pa becomes smaller than the predetermined value R.

### 5.3 Workings

According to the laser system of the present embodiment, even in a case where the seed light L10 is expanded toward both sides in the V-axis direction by the cylindrical convex mirror 136, and thereafter, the thus-expanded seed light L10 is reflected by the first and second cylindrical concave mirrors 137 and 138 to be amplified, it is possible to suppress self-oscillation.

### 6. Specific Example of Solid-State Laser Apparatus

Next, description is given of a specific configuration example of the foregoing solid-state laser apparatus 10. Note that substantially same components as the components of the laser systems according to the foregoing comparative example and the foregoing first to third embodiments are denoted by same reference numerals, and redundant description thereof is omitted.

### 6.1 Configuration

FIG. 21 schematically illustrates a specific configuration example of the solid-state laser apparatus 10 together with a configuration example of a laser apparatus 1 used for an exposure apparatus. As the laser apparatus 1 used for the exposure apparatus, any of the laser systems according to the first to third embodiments may be applicable.

The laser apparatus 1 used for the exposure apparatus may include the solid-state laser apparatus 10, the controller 7, and the high reflection mirrors 98 and 99. The controller 7 may include a laser controller 3 and a synchronization controller 6. Moreover, the laser apparatus 1 used for the exposure apparatus may include one of the amplifiers 2A, 2B, 2C, and 2D. In the following, description is given of an example in which the amplifier 2C in FIG. 13 is included.

The solid-state laser apparatus 10 may include a first solid-state laser unit 11, a second solid-state laser unit 12, a synchronous circuit 13, a high reflection mirror 16, a dichroic mirror 17, and a wavelength conversion system 15.

The first solid-state laser unit 11 may be configured to output a first pulsed laser light beam L1 with a first wavelength toward the wavelength conversion system 15 via the dichroic mirror 17. The first wavelength may be about 257.5 nm. The first solid-state laser unit 11 may include a first laser diode 20, a semiconductor optical amplifier (SOA) 23, an Yb fiber amplifier system 24, and an Yb:YAG crystal amplifier 25. The first solid-state laser unit 11 may further include a LBO (LiB₃O₅) crystal 21 and a CLBO (CsLiB₆O₁₀) crystal 22 that are nonlinear crystals. The first laser diode 20, the semiconductor optical amplifier 23, the Yb fiber amplifier system 24, the Yb:YAG crystal amplifier 25, the LBO crystal 21, and the CLBO crystal 22 may be disposed in an optical path in this order from upstream to downstream.

The first laser diode 20 may be a distributed-feedback laser diode that outputs seed light with a wavelength of about 1030 nm by continuous-wave (CW) oscillation or pulse oscillation. The first laser diode 20 may be a single longitudinal mode laser diode that varies a wavelength around a wavelength of about 1030 nm.

The semiconductor optical amplifier 23 may be a semiconductor device that causes a pulse current to flow through a semiconductor, thereby converting the seed light into a pulsed laser light beam with a predetermined pulse width and amplifying the pulsed laser light beam. The semiconductor optical amplifier 23 may include an unillustrated current controller that causes the pulse current to flow through the semiconductor on the basis of an instruction from the synchronous circuit 13. The semiconductor optical amplifier 23 may be configured to operate in synchronization with the first laser diode 20 in a case where the first laser diode 20 oscillates in a pulse mode.

The Yb fiber amplifier system 24 may include a plurality of stages of optical fiber amplifiers and a CW excitation laser diode, The optical fiber amplifiers each may be doped with Yb. The CW excitation laser diode may output excited light by CW oscillation and supply the excited light to each of the optical fiber amplifiers.

The LBO crystal 21 may receive a pulsed laser light beam with a wavelength of about 1030 nm and output a pulsed laser light beam with a wavelength of about 515 nm. The CLBO crystal 22 may receive a pulsed laser light beam with a wavelength of about 515 nm and output a pulsed laser light beam with a wavelength of about 257.5 nm.

The second solid-state laser unit 12 may be configured to output a second pulsed laser light beam L2 with a second wavelength toward the wavelength conversion system 15 via the high reflection mirror 16 and the dichroic mirror 17. The second wavelength may be about 1554 nm. The second solid-state laser unit 12 may include a second laser diode 40, a semiconductor optical amplifier (SOA) 41, and an Er fiber amplifier system 42. The second laser diode 40, the semiconductor optical amplifier 41, and the Er fiber amplifier system 42 may be disposed in an optical path in this order from upstream to downstream.

The second laser diode 40 may be a distributed-feedback laser diode that outputs seed light with a wavelength of about 1554 nm by CW oscillation or pulse oscillation. The second laser diode 40 may be a single longitudinal mode laser diode that varies a wavelength around a wavelength of about 1554 nm.

The semiconductor optical amplifier 41 may be a semiconductor device that causes a pulse current to flow through a semiconductor, thereby converting the seed light into a pulsed laser light beam with a predetermined pulse width and amplifying the pulsed laser light beam. The semiconductor optical amplifier 41 may include an unillustrated current controller that causes the pulse current to flow through the semiconductor on the basis of an instruction from the synchronous circuit 13. The semiconductor optical amplifier 41 may be configured to operate in synchronization with the second laser diode 40 in a case where the second laser diode 40 oscillates in a pulse mode.

The Er fiber amplifier system 42 may include a plurality of stages of optical fiber amplifiers and a CW excitation laser diode. The optical fiber amplifiers each may be doped with both Er and Yb. The CW excitation laser diode may output excited light by CW oscillation and supply the excited light to each of the optical fiber amplifiers.

The synchronous circuit 13 may be configured to output a predetermined trigger signal to each of the semiconductor optical amplifier 23 of the first solid-state laser unit 11 and the semiconductor optical amplifier 41 of the second solid-state laser unit 12 on the basis of a trigger signal Tr1 from the synchronization controller 6.

The high reflection mirror 16 may be so disposed as to reflect the second pulsed laser light beam L2 outputted from the second solid-state laser unit 12 at high reflectivity, thereby allowing the reflected second pulsed laser light beam L2 to enter the dichroic mirror 17.

The dichroic mirror 17 may be configured of a substrate coated with a film that allows the first pulsed laser light beam L1 with the first wavelength to pass therethrough at high transmittance and reflects the second pulsed laser light beam L2 with the second wavelength at high reflectivity. The substrate may allow the first pulsed laser light beam L1 with the first wavelength to pass therethrough at high transmittance. The dichroic mirror 17 may be so disposed as to allow the first pulsed laser light beam L1 and the second pulsed laser light beam L2 to enter the wavelength conversion system 15 while optical path axes of the first and second pulsed laser light beams L1 and L2 are substantially coincident with each other.

The wavelength conversion system 15 may be configured to receive the first pulsed laser light beam L1 with the first wavelength and the second pulsed laser light beam L2 with the second wavelength and output, as the seed light L10 toward the amplifier 2C, a pulsed laser light beam with a wavelength different from the first wavelength and the second wavelength. The wavelength conversion system 15 may include CLBO crystals 18 and 19, dichroic mirrors 95 and 96, and a high reflection mirror 97. The CLBO crystal 18, the dichroic mirror 95, the CLBO crystal 19, and the dichroic mirror 96 may be disposed in an optical path in this order from upstream to downstream.

The first pulsed laser light beam L1 with a wavelength of about 257.5 nm and the second pulsed laser light beam L2 with a wavelength of about 1554 nm may enter the CLBO crystal 18. The CLBO crystal 18 may output a pulsed laser light beam with a wavelength of about 220.9 nm corresponding to a sum frequency of a wavelength of about 257.5 nm and a wavelength of about 1554 nm.

The dichroic mirror 95 may be coated with a film that allows a pulsed laser light beam with a wavelength of about 1554 nm and a pulsed laser light beam with a wavelength of about 220.9 nm to pass therethrough at high transmittance and reflects a pulsed laser light beam with a wavelength of about 257.5 nm at high reflectivity.

The pulsed laser light beam a wavelength of about 1554 nm and the pulsed laser light beam with a wavelength of about 220.9 nm having passed through the dichroic mirror 95 may enter the CLBO crystal 19. The CLBO crystal 19 may output, as the seed light L10, a pulsed laser light beam with a wavelength of about 193.4 nm corresponding to a sum frequency of a wavelength of about 1554 nm and a wavelength of about 220.9 nm.

The dichroic mirror 96 may be coated with a film that allows a pulsed laser light beam with a wavelength of about 1554 nm and a pulsed laser light beam with a wavelength of about 220.9 nm to pass therethrough at high transmittance and reflects a pulsed laser light beam with a wavelength of about 193.4 nm at high reflectivity.

The high reflection mirror 97 may be so disposed as to allow the solid-state laser apparatus 10 to output, as the seed light L10, the pulsed laser light beam with a wavelength of about 193.4 nm reflected by the dichroic mirror 96.

The high reflection mirrors 98 and 99 may be so disposed as to allow the seed light L10 with a wavelength of about 193.4 nm outputted from the solid-state laser apparatus 10 to enter the amplifier 2C.

The amplifier 2C may be configured to amplify the seed light L10 with a wavelength of about 193.4 nm outputted from the solid-state laser apparatus 10 and output the thus-amplified seed light L10 as the amplified laser light L20 toward the exposure apparatus 4.

The laser controller 3 may be coupled to the first laser diode 20, the second laser diode 40, the CW excitation laser diode in the Yb fiber amplifier system 24, and the CW excitation laser diode in the Er fiber amplifier system 42 through unillustrated signal lines.

The synchronization controller 6 may be supplied with an oscillation trigger signal Tr0 from the exposure apparatus 4 as an external apparatus via the laser controller 3. The oscillation trigger signal Tr0 may indicate a timing of generating a pulsed laser light beam in the solid-state laser apparatus 10. The exposure apparatus 4 may include an exposure apparatus controller 5. The exposure apparatus controller 5 of the exposure apparatus 4 may supply the oscillation trigger signal Tr. The synchronization controller 6 may be configured to generate the trigger signal Tr1 on the basis of the oscillation trigger signal Tr0 and supply the thus-generated trigger signal Tr1 to the synchronous circuit 13. Moreover, the synchronization controller 6 may be configured to generate a trigger signal Tr2 on the basis of the oscillation trigger signal Tr0 and supply the thus-generated trigger signal Tr2 to the amplifier 2C.

### 6.2 Operation

The laser controller 3 may cause the first and second laser diodes 20 and 40 to oscillate in a CW mode or in a pulse mode on the basis of the oscillation trigger signal Tr0. Moreover, the laser controller 3 may cause the CW excitation laser diode in the Yb fiber amplifier system 24 and the CW excitation laser diode in the Er fiber amplifier system 42 to oscillate in the CW mode on the basis of the oscillation trigger signal Tr0.

The synchronization controller 6 may control a delay time between the oscillation trigger signal Tr0 and the trigger signal Tr1 and a delay time between the oscillation trigger signal Tr0 and the trigger signal Tr2 upon reception of the oscillation trigger signal Tr0 from the exposure apparatus controller 5 via the laser controller 3. The delay times may be so controlled as to cause discharge to occur between the pair of discharge electrodes 38a and 38b in synchronization with entry of the seed light L10 outputted from the solid-state laser apparatus 10 to the amplifier 2C.

In the first solid-state laser unit 11, the first laser diode 20 may output CW-oscillated light or pulse-oscillated light with a wavelength of about 1030 nm as the seed light. The semiconductor optical amplifier 3 may convert the seed light into a pulsed laser light beam with a predetermined pulse width on the basis of a predetermined trigger signal from the synchronous circuit 13 and amplify the pulsed laser light beam. The pulsed laser light beam outputted from the semiconductor optical amplifier 23 may enter the Yb fiber amplifier system 24, and may be amplified by the Yb fiber amplifier system 24. The pulsed laser light beam outputted from the Yb fiber amplifier system 24 may enter the Yb:YAG crystal amplifier 25, and may be amplified by the Yb:YAG crystal amplifier 25. The pulsed laser light beam outputted from the Yb:YAG crystal amplifier 25 may enter the LBO crystal 21. Thereafter, the LBO crystal 21 and the CLBO crystal 22 may generate a fourth harmonic with a wavelength of about 257.5 nm from the pulsed laser light beam. Thus, the first solid-state laser unit 11 may output the first pulsed laser light beam L1 with a wavelength of about 257.5 nm.

In contrast, in the second solid-state laser unit 12, the second laser diode 40 may output CW-oscillated light or pulse-oscillated light with a wavelength of about 1554 nm as the seed light. The semiconductor optical amplifier 41 may convert the seed light into a pulsed laser light beam with a predetermined pulse width on the basis of the predetermined trigger signal from the synchronous circuit 13 and amplify the pulsed laser light beam. The pulsed laser light beam outputted from the semiconductor optical amplifier 41 may enter the Er fiber amplifier system 42, and may be amplified by the Er fiber amplifier system 42. Thus, the second solid-state laser unit 12 may output the second pulsed laser light beam L2 with a wavelength of about 1554 nm.

The first pulsed laser light beam L1 with a wavelength of about 257.5 nm outputted from the first solid-state laser unit 11 may enter the wavelength conversion system 15 via the dichroic mirror 17. Moreover, the second pulsed laser light beam L2 with a wavelength of about 1554 nm outputted from the second solid-state laser unit 12 may enter the wavelength conversion system 15 via the high reflection mirror 16 and the dichroic mirror 17.

At this occasion, the synchronous circuit 13 may supply a trigger signal with a predetermined pulse width at a predetermined timing to each of the semiconductor optical amplifiers 23 and 41 on the basis of the trigger signal Tr1. The predetermined timing may be so adjusted as to allow the first pulsed laser light beam L1 and the second pulsed laser light beam L2 to enter the CLBO crystal 18 of the wavelength conversion system 15 at a substantially coincidental timing. The pulse width of the trigger signal to be supplied to the semiconductor optical amplifier 23 may be so adjusted as to allow the pulse width of the first pulsed laser light beam L1 to fall in, for example, a range from 1 nsec to 30 nsec both inclusive. The pulse width of the trigger signal to be supplied to the semiconductor optical amplifier 41 may be so adjusted as to allow the pulse width of the second pulsed laser light beam L2 to fall in, for example, a range from 1 nsec to 30 nsec both inclusive. Accordingly, the pulse width of the seed light L10 to be outputted from the solid-state laser apparatus 10 may be so adjusted as to fall in, for example, a range from 1 nsec to 30 nsec both inclusive.

In the wavelength conversion system 15, the dichroic mirror 17 may cause the first pulsed laser light beam L1 and the second pulsed laser light beam L2 to enter the CLBO crystal 18 at a substantially coincidental timing and be superimposed on each other on the CLBO crystal 18. The CLBO crystal 18 may generate a pulsed laser light beam with a wavelength of about 220.9 nm corresponding to a sum frequency of a wavelength of about 257.5 nm and a wavelength of about 1554 nm. The CLBO crystal 18 may output three pulsed laser light beams, i.e., a pulsed laser light beam with a wavelength of about 257.5 nm, a pulsed laser light beam with a wavelength of about 1554 nm, and a pulsed laser light beam with a wavelength of about 220.9 nm.

The dichroic mirror 95 may allow the pulsed laser light beam with a wavelength of about 1554 nm and the pulsed laser light beam with a wavelength of about 220.9 nm of the three pulsed laser light beams outputted from the CLBO crystal 18 to pass therethrough at high transmittance and may reflect the pulsed laser light beam with a wavelength of about 257.5 nm of the three pulsed laser light beams outputted from the CLBO crystal 18 at high reflectivity. The two pulsed laser light beams having passed through the dichroic mirror 95 may enter the CLBO crystal 19.

The CLBO crystal 19 may generate a pulsed laser light beam with a wavelength of about 193.4 nm corresponding to a sum frequency of a wavelength of about 220.9 nm and a wavelength of about 1554 nm. The CLBO crystal 19 may output three pulsed laser light beams, i.e., a pulsed laser light beam with a wavelength of about 1554 nm, a pulsed laser light beam with a wavelength of about 220.9 nm, and a pulsed laser light beam with a wavelength of about 193.4 nm.

The dichroic mirror 96 may allow the pulsed laser light beam with a wavelength of about 1554 nm and the pulsed laser light beam with a wavelength of about 220.9 nm of the three pulsed laser light beams outputted from the CLBO crystal 19 to pass therethrough at high transmittance, and may reflect the pulsed laser light beam with a wavelength of about 193.4 nm of the three pulsed laser light beams outputted from the CLBO crystal 19 at high reflectivity. The pulsed laser light beam with a wavelength of about 193.4 nm may be outputted as the seed light L10 from the wavelength conversion system 15 via the high reflection mirror 97, The seed light L10 outputted from the wavelength conversion system 15 may enter the amplifier 2C via the high reflection mirrors 98 and 99.

In the amplifier 2C, discharge may occur between the pair of discharge electrodes 38a and 38b in the discharge clearance 50 in synchronization with entry of the seed light L10, as illustrated in FIG. 13. The amplifier 2C may adjust a timing of power supply by the pulse power source 34 for discharge of the pair of discharge electrodes 38a and 38b so as to efficiently amplify the seed light L10 from the solid-state laser apparatus 10. In the amplifier 2C, the seed light L10 may be reflected by the cylindrical convex mirror 36 and the cylindrical concave mirror 37, which may cause the seed light L10 to pass through the discharge clearance 50 between the pair of discharge electrodes 38a and 38b three times. Accordingly, the seed light L10 may be amplified while expanding the beam of the seed light L10. As described above, the seed light L10 outputted from the solid-state laser apparatus 10 may be amplified by the amplifier 2C, and may be outputted as the amplified laser light L20 toward the exposure apparatus 4.

### 7. Hardware Environment of Controller

A person skilled in the art will appreciate that a general-purpose computer or a programmable controller may be combined with a program module or a software application to execute any subject matter disclosed herein. The program module, in general, may include one or more of a routine, a program, a component, a data structure, and so forth that each causes any process described in any example embodiment of the present disclosure to be executed.

FIG. 22 is a block diagram illustrating an exemplary hardware environment in which various aspects of any subject natter disclosed therein may be executed. An exemplary hardware environment 100 in FIG. 22 may include a processing unit 1000, a storage unit 1005, a user interface 1010, a parallel input/output (I/O) controller 1020, a serial I/O controller 1030, and an analog-to-digital (A/D) and digital-to-analog (D/A) converter 1040. Note that the configuration of the hardware environment 100 is not limited thereto.

The processing unit 1000 may include a central processing unit (CPU) 1001, a memory 1002, a tinier 1003, and a graphics processing unit (GPU) 1004. The memory 1002 may include a random access memory (RAM) and a read only memory (ROM). The CPU 1001 may be any commercially-available processor. A dual microprocessor or any other multi-processor architecture may be used as the CPU 1001.

The components illustrated in FIG. 22 may be coupled to one another to execute any process described in any example embodiment of the present disclosure.

Upon operation, the processing unit 1000 may load programs stored in the storage unit 1005 to execute the loaded programs. The processing unit 1000 may read data from the storage unit 1005 together with the programs, and may write data in the storage unit 1005. The CPU 1001 may execute the programs loaded from the storage unit 1005. The memory 1002 may be a work area in which programs to be executed by the CPU 1001 and data to be used for operation of the CPU 1001 are held temporarily. The timer 1003 may measure time intervals to output a result of the measurement to the CPU 1001 in accordance with the execution of the programs. The GPU 1004 may process image data in accordance with the programs loaded from the storage unit 1005, and may output the processed image data to the CPU 1001.

The parallel I/0 controller 1020 may be coupled to parallel I/O devices operable to perform communication with the processing unit 1000, and may control the communication performed between the processing unit 1000 and the parallel I/O devices. Non-limiting examples of the parallel I/O devices may include the laser controller 3, the synchronization controller 6, and the controller 7. The serial I/O controller 1030 may be coupled to a plurality of serial I/O devices operable to perform communication with the processing unit 1000, and may control the communication performed between the processing unit 1000 and the serial I/O devices. Non-limiting examples of serial I/O devices may include the laser controller 3, the synchronization controller 6, and the controller 7. The A/D and D/A converter 1040 may be coupled to various kinds of sensors and analog devices through respective analog ports. Non-limiting examples of the analog devices may include the semiconductor optical amplifiers 23 and 41, and the pulse energy sensor 93. The A/D and D/A converter 1040 may control communication performed between the processing unit 1000 and the analog devices, and may perform analog-to-digital conversion and digital-to-analog conversion of contents of the communication.

The user interface 1010 may provide an operator with display showing a progress of the execution of the programs executed by the processing unit 1000, such that the operator is able to instruct the processing unit 1000 to stop execution of the programs or to execute an interruption routine.

The exemplary hardware environment 100 may be applied to one or more of configurations of the controller 7, the exposure apparatus controller 5, and other controllers according to any example embodiment of the present disclosure. A person skilled in the art will appreciate that such controllers may be executed in a distributed computing environment, namely, in an environment where tasks may be performed by processing units linked through any communication network. In any example embodiment of the present disclosure, controllers such as the controller 7 and the exposure apparatus controller 5 may be coupled to one another through a communication network such as Ethernet (Registered Trademark) or the Internet. In the distributed computing environment, the program module may be stored in each of local and remote memory storage devices.

### 8. Et Cetera

The foregoing description is intended to be merely illustrative rather than limiting. It should therefore be appreciated that variations may be made in example embodiments of the present disclosure by persons skilled in the art without departing from the scope as defined by the appended claims.

The terms used throughout the specification and the appended claims are to be construed as “open-ended” terms. For example, the term “include” and its grammatical variants are intended to be non-limiting, such that recitation of items in a list is not to the exclusion of other like items that can be substituted or added to the listed items. The term “have” and its grammatical variants are intended to be non-limiting, such that recitation of items in a list is not to the exclusion of other like items that can be substituted or added to the listed items. Also, the singular forms “a”, “an”, and “the” used in the specification and the appended claims include plural references unless expressly and unequivocally limited to one referent.

What is claimed is:

1. An amplifier, comprising:
a chamber including a pair of discharge electrodes, a laser exciting medium, an input window, and an output window, the pair of discharge electrodes being opposed to each other in a first direction, the input window allowing seed light to pass therethrough into the chamber, and the output window allowing amplified laser light to pass therethrough to outside in a second direction intersecting with the first direction; and
a first mirror and a second mirror each including a reflection region, and opposed to each other in a third direction with the pair of discharge electrodes in between, the third direction intersecting with the first direction, and a projected image of the reflection region of the first mirror in the second direction and a projected image of the reflection region of the second mirror in the second direction providing a gap of a size equal to or greater than zero in between.

2. The amplifier according to claim 1, wherein the first mirror is a convex mirror, and the second mirror is a concave mirror.

3. The amplifier according to claim 2, wherein the convex mirror is a cylindrical convex mirror, and the concave mirror is a cylindrical concave mirror.

4. The amplifier according to claim 1, wherein
the second mirror includes a plurality of mirror elements each including a reflection region; and
the projected image of the reflection region of the first mirror in the second direction and a projected image of the reflection region of each of the mirror elements in the second direction provide a gap of a size equal to or greater than zero in between.

5. The amplifier according to claim 1, wherein the first mirror and the second mirror configure a beam expander.

6. The amplifier according to claim 5, wherein a beam expanding direction of the beam expander substantially coincides with a discharging direction between the pair of discharge electrodes.

7. The amplifier according to claim 1, further comprising an adjuster mechanism configured to adjust the size of the gap.

8. The amplifier according to claim 1, wherein the gap is smaller than a distance between the pair of discharge electrodes.

9. The amplifier according to claim 1, wherein the following relationship is satisfied:
c·Td<2L
where the seed light is a pulsed laser light beam, Td is a pulse width of the seed light, L is a mirror distance in the second direction from the first mirror to the second mirror, and c is light speed.

10. The amplifier according to claim 7, further comprising:
a pulse energy monitor; and
a controller, wherein
the seed light is a pulsed laser light beam,
the pulse energy monitor is configured to detect pulse energy of the amplified laser light, and
the controller is configured to control the size of the gap with use of the adjuster mechanism on a basis of the detected pulse energy.

11. A laser system, comprising:
an oscillator configured to output seed light; and
an amplifier provided in an optical path of the seed light,
the amplifier including:
a chamber including a pair of discharge electrodes, a laser exciting medium, an input window, and an output window, the pair of discharge electrodes being opposed to each other in a first direction, the input window allowing the seed light to pass therethrough into the chamber, and the output window allowing amplified laser light to pass therethrough to outside in a second direction intersecting with the first direction; and
a first mirror and a second mirror each including a reflection region, and opposed to each other in a third direction with the pair of discharge electrodes in between, the third direction intersecting with the first direction, and a projected image of the reflection region of the first mirror in the second direction and a projected image of the reflection region of the second mirror in the second direction providing a gap of a size equal to or greater than zero in between.

12. The laser system according to claim 11, wherein the oscillator is a solid-state laser apparatus.

13. The laser system according to claim 11, further comprising an optical device provided in the optical path of the seed light between the oscillator and the amplifier to allow the seed light outputted from the oscillator to enter the first mirror.
